(19) United States
(12) Patent Application Publication
(10) Pub. No.: US 2026/0094400 A1
(43) Pub. Date: Apr. 2, 2026

(54) IMPLEMENTING AUTOMATIC LAYER DECOMPOSITION

(71) Applicant: Lemon Inc., Grand Cayman (KY)

(72) Inventors: Ye Yuan, Los Angeles, CA (US); Lu Xu, Los Angeles, CA (US); Fangyi Chen, Los Angeles, CA (US); Longyin Wen, Los Angeles, CA (US)

(21) Appl. No.: 18/902,810

(22) Filed: Sep. 30, 2024

(51) Int. Cl. G06V 10/25; G06T 5/77; G06T 7/12; G06T 7/50; G06V 20/70; G06V 30/10

(52) U.S. Cl. CPC G06V 10/25; G06T 5/77; G06T 7/12; G06T 7/50; G06V 20/70; G06V 30/10; G06V 2201/07

(57) ABSTRACT

Techniques for implementing automatic layer decomposition are provided. An image comprising a plurality of objects is received. Object detection results are generated based on detecting the plurality of objects in the image. The object detection results comprising an object detection result corresponding to each of the plurality of objects. Textual descriptions of the image are generated. The textual descriptions comprise a textual description corresponding to each of the plurality of objects. The object detection result is associated with the textual description corresponding to each of the plurality of objects. Depth estimation results are generated by predicting a depth map of the image. The depth estimation results comprise a depth estimation result corresponding to each of the plurality of objects. The plurality of objects are merged into layers based on the object detection result, the textual description, and the depth estimation result corresponding to each of the plurality of objects.

### BACKGROUND

Machine learning models are increasingly being used across a variety of industries to perform a variety of different tasks. Such tasks may include image processing. Improved techniques for utilizing machine learning models for image processing are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for implementing automatic layer decomposition in accordance with the present disclosure.

FIG. 2 shows an example system for implementing automatic layer decomposition in accordance with the present disclosure.

FIG. 3 shows an example system for implementing automatic layer decomposition in accordance with the present disclosure.

FIG. 4 shows an example processed image in accordance with the present disclosure.

FIG. 5 shows an example process for implementing automatic layer decomposition in accordance with the present disclosure.

FIG. 6 shows an example process for implementing automatic layer decomposition in accordance with the present disclosure.

FIG. 7 shows an example process for implementing automatic layer decomposition in accordance with the present disclosure.

FIG. 8 shows an example process for implementing automatic layer decomposition in accordance with the present disclosure.

FIG. 9 shows an example process for implementing automatic layer decomposition in accordance with the present disclosure.

FIG. 10 shows an example process for implementing automatic layer decomposition in accordance with the present disclosure.

FIG. 11 shows an example computing device which may be used to perform any of the techniques disclosed herein.

### DETAILED DESCRIPTION OF ILLUSTRATIVE EMBODIMENTS

Decomposing an image into layers can be useful for a variety of different image processing tasks, such as for instance detection, masking, matting, amodal completion, scene graphic generation, depth ordering, and the addition of special effects (e.g., lighting, atmosphere, etc.). Decomposing an image into layers can enable precise editing of individual layers of the image without affecting the other layers of the image. However, decomposing an image into multiple semantically meaningful layers can require a variety of complex techniques for scene understanding, such as region-level reasoning, depth-aware localization, open-vocabulary semantics, amodal segmentation, inpainting, etc. Further, it can be especially difficult to decompose an image into multiple semantically meaningful layers if the image comprises multiple occlusion relationships (e.g., one or more objects occluding one or more other objects). As such, improved techniques for implementing layer decomposition are needed.

Described herein are improved techniques for image processing using machine learning models. Described herein is a system that utilizes techniques to segment, describe, combine, sort and complete objects in images. The system described herein is able to support the processing of images with multiple layers of objects and multiple occlusion relationships. The system described herein functions as an end-to-end data pipeline for layer decomposition that is able to support the removal or addition of any image layer.

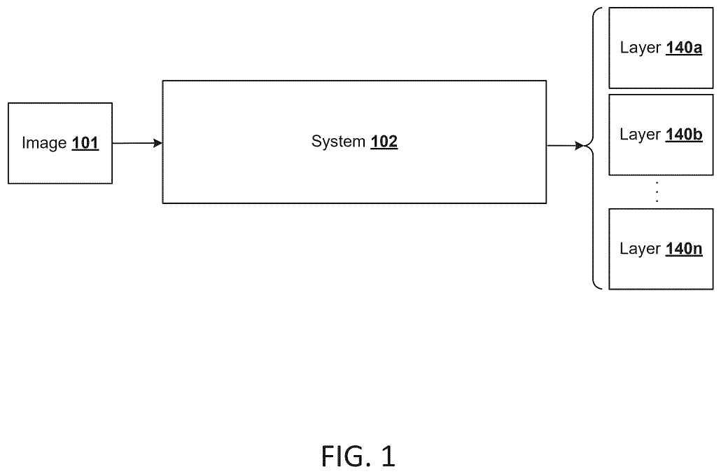

FIG. 1 illustrates an example system 102 in accordance with the present disclosure. The system 102 can receive, as input, an image 101. The image 101 may comprise, or depict, a plurality of objects. In some embodiments, at least one of the plurality of objects in the image 101 is at least partially occluded by (e.g., blocked by) one or more other objects among the plurality of objects. The system 102 can merge the plurality of objects into layers 104a-b. Each of the layers 140a-n can preserve the corresponding visible content in the image 101 while also completing the invisible (e.g., occluded) content in the image 101, with high quality.

The layers 140a-n can be used to perform an image editing task. For example, a user can combine one or more of the layers 140a-n to generate an edited version of the image 101. A user can edit one or more of the individual layers without affecting the other layers. In some embodiments, the image 101 and the layers 140a-n can be used as training data for training a machine learning model to decompose images into layers. For example, the image 101 and the layers 140a-n can form a training data pair. The training data pair can be input (along with many other similar training data pairs) into a machine learning model to train the machine learning model to decompose images into layers.

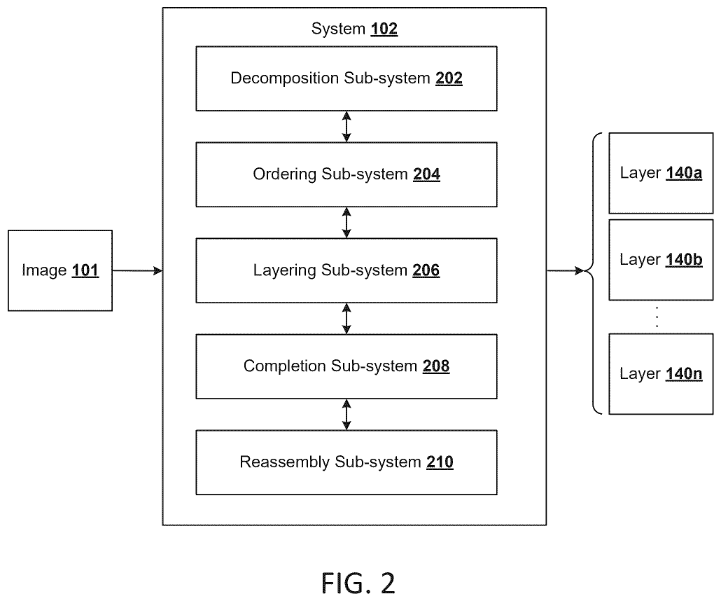

FIG. 2 illustrates the example system 102 in more detail. The system 102 can include a series of sub-systems to segment, describe, combine, sort and complete objects in images. For example, the system 102 can include a decomposition sub-system 202, an ordering sub-system 204, a layering sub-system 206, a completion sub-system 208, and a reassembly sub-system 210.

The decomposition sub-system 202 can be configured to receive, as input, the image 101. The decomposition sub-system 202 can generate, based on the image 101, object instance-level annotations. The object instance-level annotations can, for example, label the pixels in the image 101 to accurately describe the plurality of objects. The ordering sub-system 204 can be configured to receive, as input, the image 101. The ordering sub-system 204 can be configured to sort the plurality of objects, such as in a foreground to background order. The layering sub-system 206 can be configured to receive, as input, the image 101. The layering sub-system 206 can be configured to merge closely related objects into layers. The layering sub-system 206 can merge the closely related objects into the layers based on the object instance-level annotations and depth estimation results (e.g., a depth map for the image 101).

The completion sub-system 208 can be configured to receive, as input, the image 101. The completion sub-system 208 can be configured to use image inpainting models to generate a completed image for each of the layers and for the background of the image 101. If at least one of the plurality of objects in the image 101 is occluded by one or more other objects among the plurality of objects, the completed layer images can depict an entirety of the at least one of the plurality of objects as if it was not occluded by the one or more other objects. Each of the completed layer images can include a red, green, blue (RGB) image. The reassembly sub-system 210 can be configured to receive, as input, the completed layer images. The reassembly sub-system 210 can be configured to generate a refined mask (e.g., an alpha mask, an alpha channel) for each of the completed layer images. The reassembly sub-system 210 can use alpha generation models to transform each of the completed layer images and the corresponding refined layer mask into a red, green, blue, alpha (RGBA) image. The layers 140a-n can include the RGBA images.

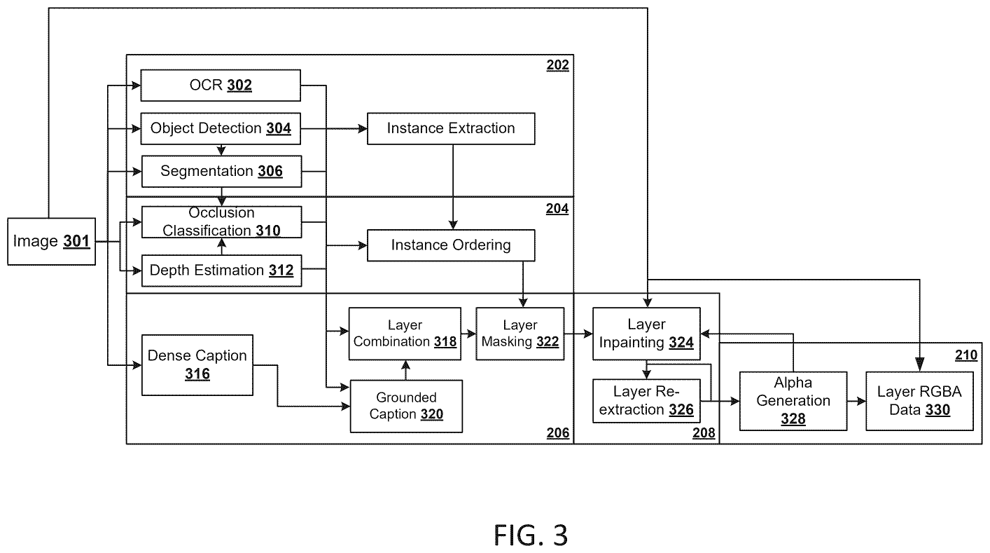

FIG. 3 illustrates the example system 102 in more detail. The system 102 can receive, as input, an image 301. The image 301 may comprise, or depict, a plurality of objects. In some embodiments, at least one of the plurality of objects in the image 301 is at least partially occluded by (e.g., blocked by) one or more other objects among the plurality of objects.

The image 301 can be input into the decomposition sub-system 202. The decomposition sub-system 202 can include an Optical Character Recognition (OCR) model 302. The OCR model 302 can be configured to extract text from the image 301 by performing OCR on the image 301 to generate an OCR result. The decomposition sub-system 202 can include an object detection model 304. The object detection model 304 can generate object detection results based on detecting the plurality of objects in the image 301. The object detection results can include an object detection result corresponding to each of the plurality of objects. Generating the object detection results based on detecting the plurality of objects in the image can include detecting object bounding boxes and labels associated with the plurality of objects. The decomposition sub-system 202 can include a segmentation model 306. The segmentation model 306 can generate segmentation masks for the plurality of objects. The segmentation model 306 can generate segmentation masks for the plurality of objects based on the object detection results. The OCR result, the object detection results, and the segmentation masks can be combined to form object instance-level annotations.

The image 301 can be input into the ordering sub-system 204. The ordering sub-system 204 can include an occlusion classification model 310. The occlusion classification model 310 can generate occlusion relation graphs associated with the image 301. The occlusion relation graphs associated with the image 301 can include, for example, an occlusion dependency graph (ODG) data structure that represents the occlusion relationship among the plurality of objects. The ordering sub-system 204 can include a depth estimation model 312. The depth estimation model 312 can generate depth estimation results by predicting a depth map of the image 301. The depth estimation results can include a depth estimation result corresponding to each of the plurality of objects. The depth estimation results and the occlusion relation graphs can be combined to sort object instances in a foreground-to-background order.

The image 301 can be input into the layering sub-system 206. The layering sub-system 206 can include a dense caption model 316. The dense caption model 316 can generate a textual description of the image 301. The textual description of the image 301 can include a textual description corresponding to each of the plurality of objects. The dense caption model 316 can generate the textual description of the image 301 using a machine learning model, such as a multi-model large language model or a large vision-language model. The image 301 and a prompt can be input into the machine learning model. The prompt can instruct the machine learning model to generate a textual description corresponding to each of the plurality of objects in the image 301. The machine learning model can generate the textual description of the image 301 based on the image 301 and the prompt.

The layering sub-system 206 can include a grounded caption model 320. The grounded caption model 320 can receive the textual description of the image 301 as input. The grounded caption model 320 can receive the object detection results as input. The grounded caption model 320 can merge the dense caption results (e.g., the textual description of the image 301) and the object detection results into a grounded caption. In the grounded caption, objects in the caption can be associated with their respective bounding boxes. The grounded caption model 320 can merge the dense caption results and the object detection results into a grounded caption using a machine learning model, such as a large language model. The textual description of the image 301 and a prompt can be input into the machine learning model. The prompt can instruct the machine learning model to generate the grounded caption based on the textual description of the image 301. The machine learning model can generate the grounded caption.

The layering sub-system 206 can include a layer combination model 318. The layer combination model 318 can receive the grounded caption as input. The layer combination model 318 can receive the object instance-level annotations as input. The layer combination model 318 can receive the depth estimation results. The layer combination model 318 can merge closely related objects into layers based on the grounded caption, the object instance-level annotations, and the depth estimation results. The layer combination model 318 can merge closely related objects into layers using a machine learning model, such as a large language model. The layer combination model 318 can input the object instance-level annotations, the depth estimation results, and a prompt into the machine learning model. The prompt can instruct the machine learning model to merge closely related objects into layers based on the grounded caption, the object instance-level annotations, and the depth estimation results.

The layering sub-system 206 can include a layer masking model 322. The layer masking model 322 can receive data indicating layers from the layer combination model 318. The layer masking model 322 can receive data indicating the sorted plurality of objects (e.g., the plurality of objects sorted in a foreground-to-background order) from the ordering sub-system 204. The layer masking model 322 can generate an inpainting mask corresponding to each of the layers.

The completion sub-system 208 can include a layer inpainting model 324. The layer inpainting model 324 can receive, as input, the image 301. The layer inpainting model 324 can receive data indicating the inpainting mask corresponding to each of the layers generated by the layer masking model 322. The layer inpainting model 324 can generate completed layer images using an image inpainting model. The completed layer images can include a completed layer image corresponding to each of the layers. The completed layer images can include a completed background layer image. The completed background layer image can depict an entirety of the background of the image as if the background was not occluded by any objects in the image. If at least one of the plurality of objects in the image 301 is occluded by one or more other objects among the plurality of objects, the completed layer images can depict an entirety of the at least one of the plurality of objects as if it was not occluded by the one or more other objects. Each of the completed layer images can include a red, green, blue (RGB) image. The completion sub-system 208 can include a layer re-extraction model 326. The layer re-extraction model 326 can re-extract the layers based on the completed layer images for generating alpha channels of the layers.

The reassembly sub-system 210 can include an alpha generation model 328. The alpha generation model 328. The alpha generation model 328 can be configured to receive, as input, the completed layer images and/or the re-extracted layers. The alpha generation model 328 can be configured to generate refined layer masks based on the completed layer images. The refined layer masks can include a refined mask (e.g., an alpha mask, an alpha channel) for each of the completed layer images. The reassembly sub-system 210 can use alpha generation models to transform each of the completed layer images and the corresponding refined layer mask into layer red, green, blue, alpha (RGBA) data 330. The layer RGBA data 330 can be used to generate a RGBA image indicative of each of the completed layers.

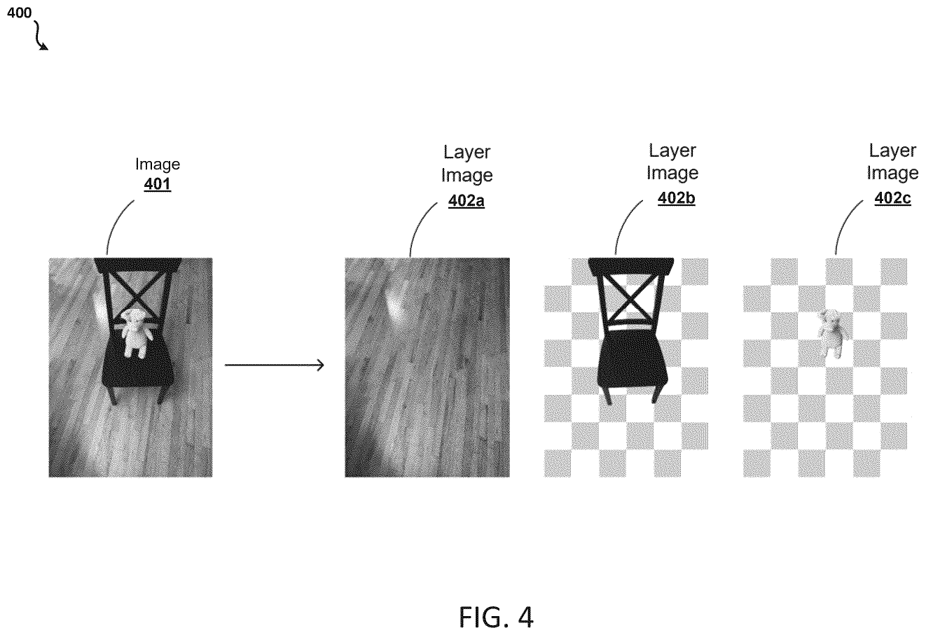

FIG. 4 shows an example system 400 for decomposing an image 401. The image 401 can depict a stuffed animal sitting in a chair that is placed on a floor. The system 102 can decompose the image 401 into a plurality of layers. For example, the system 102 can generate a plurality of layer images 402a-c. The first layer image 402a can depict the background of the image 401 (e.g., the floor). The second layer image 402b can depict a first object in the image 401 (e.g., the chair). The third layer image 402c can depict a second object in the image 401 (e.g., the stuffed animal). In embodiments, the user can edit one or more of the plurality of layer images 402a-c without affecting the other layer images among the plurality of layer images 402a-c. The image 401 can be edited based on the layer images 402a-c. A user can combine one or more of the layer images 402a-c to generate an edited version of the image 401. In other embodiments, the image 401 and the plurality of layer images 402a-c can be used as training data for training a machine learning model to decompose images into layers.

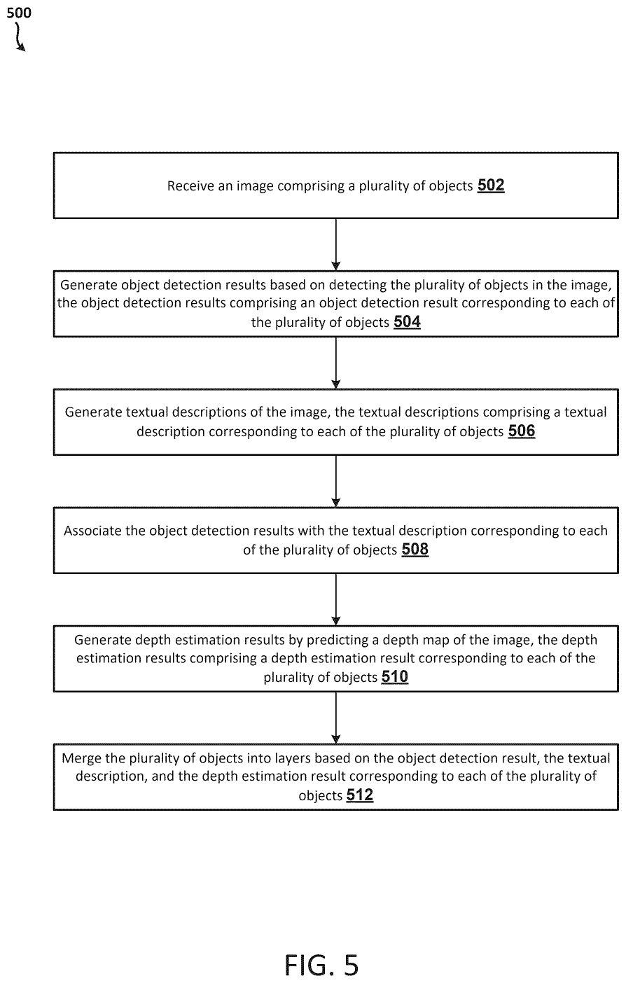

FIG. 5 shows an example process 500 for implementing automatic layer decomposition. Although depicted as a sequence of operations in FIG. 5, those of ordinary skill in the art will appreciate that various embodiments may add, remove, reorder, or modify the depicted operations.

At 502, an image (e.g., image 101, image 301, image 401) can be received. The image can include or depict a plurality of objects. The image may comprise, or depict, a plurality of objects. At 504, object detection results can be generated. The object detection results can be generated based on detecting the plurality of objects in the image. The object detection results can include an object detection result corresponding to each of the plurality of objects.

At 506, textual descriptions of the image can be generated. The textual descriptions can include a textual description corresponding to each of the plurality of objects. The textual descriptions of the image can be generated using a machine learning model, such as a multi-model large language model or a large vision-language model. The image and a prompt can be input into the machine learning model. The prompt can instruct the machine learning model to generate a textual description corresponding to each of the plurality of objects in the image. The machine learning model can generate the textual descriptions of the image based on the image and the prompt.

At 508, the object detection results can be associated with the textual description corresponding to each of the plurality of objects. The object detection results can be associated with the textual description corresponding to each of the plurality of objects using a machine learning model, such as a large language model. The prompt can instruct the machine learning model to associate the object detection result with the textual description corresponding to each of the plurality of objects.

At 510, depth estimation results can be generated. The depth estimation results can be generated by predicting a depth map of the image. The depth estimation results can include a depth estimation result corresponding to each of the plurality of objects. At 512, the plurality of objects can be merged into layers. The plurality of objects can be merged into layers based on the object detection result, the textual description, and the depth estimation result corresponding to each of the plurality of objects.

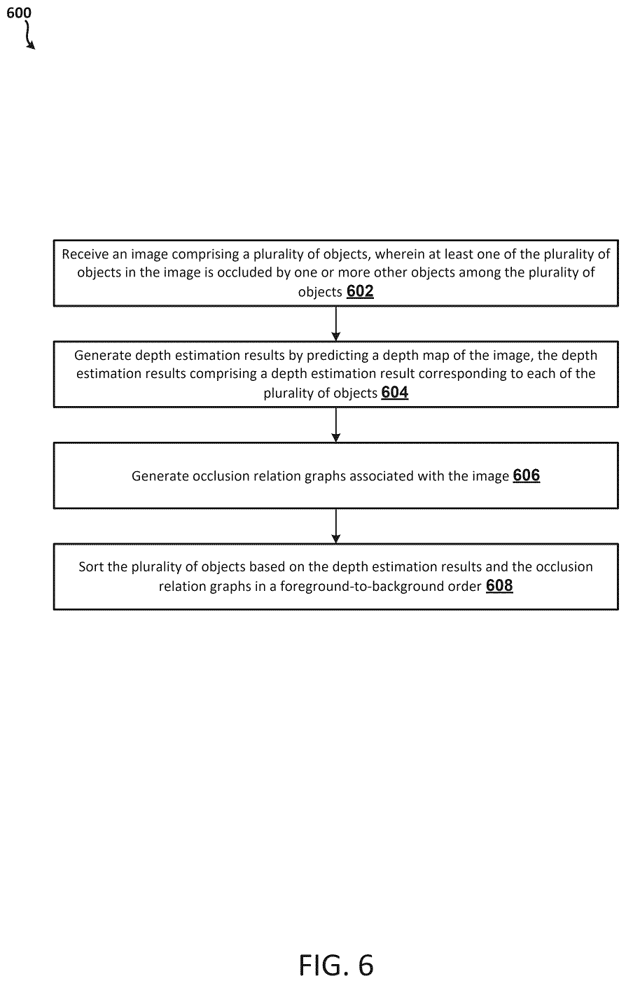

FIG. 6 shows an example process 600 for implementing automatic layer decomposition. Although depicted as a sequence of operations in FIG. 6, those of ordinary skill in the art will appreciate that various embodiments may add, remove, reorder, or modify the depicted operations.

At 602, an image (e.g., image 101, image 301, image 401) can be received. The image can include or depict a plurality of objects. The image may comprise, or depict, a plurality of objects. At least one of the plurality of objects in the image can be at least partially occluded by (e.g., blocked by) one or more other objects among the plurality of objects. At 604, depth estimation results can be generated. The depth estimation results can be generated by predicting a depth map of the image. The depth estimation results can include a depth estimation result corresponding to each of the plurality of objects.

At 606, occlusion relation graphs associated with the image can be generated. The occlusion relation graphs associated with the image can include, for example, an occlusion dependency graph (ODG) data structure that represents the occlusion relationship among the plurality of objects. At 608, the plurality of objects can be sorted. The plurality of objects can be sorted based on the depth estimation results. Additionally, or alternatively, the plurality of objects can be sorted based on the occlusion relation graphs. The plurality of objects can be sorted in a foreground-to-background order.

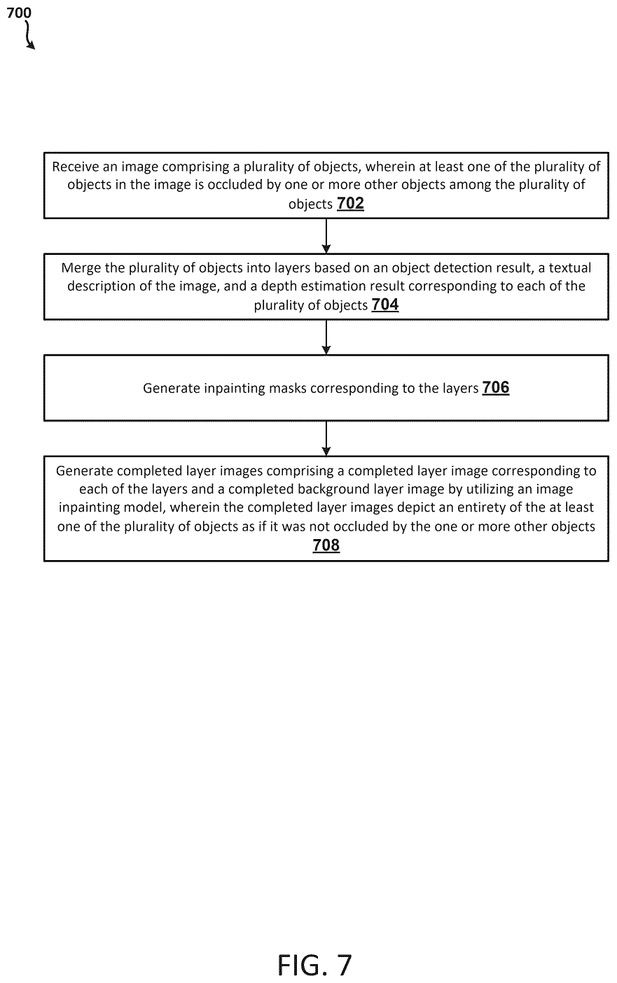

FIG. 7 shows an example process 700 for implementing automatic layer decomposition. Although depicted as a sequence of operations in FIG. 7, those of ordinary skill in the art will appreciate that various embodiments may add, remove, reorder, or modify the depicted operations.

At 702, an image (e.g., image 101, image 301, image 401) can be received. The image can include or depict a plurality of objects. The image may comprise, or depict, a plurality of objects. At least one of the plurality of objects in the image can be at least partially occluded by (e.g., blocked by) one or more other objects among the plurality of objects.

Object detection results can be generated. The object detection results can be generated based on detecting the plurality of objects in the image. The object detection results can include an object detection result corresponding to each of the plurality of objects. Textual descriptions of the image can be generated. The textual descriptions can include a textual description corresponding to each of the plurality of objects. The textual description of the image can be generated using a machine learning model, such as a multi-model large language model or a large vision-language model. Depth estimation results can be generated. The depth estimation results can be generated by predicting a depth map of the image. The depth estimation results can include a depth estimation result corresponding to each of the plurality of objects. At 704, the plurality of objects can be merged into layers. The plurality of objects can be merged into layers based on the object detection result, the textual description, and the depth estimation result corresponding to each of the plurality of objects.

At 706, inpainting masks can be generated. The inpainting masks can correspond to the layers. At 708, completed layer images can be generated. The completed layer images can include a completed layer image corresponding to each of the layers and a completed background layer image. The completed layer images can be generated utilizing an image inpainting model. The completed layer images can be generated based on the inpainting masks. The completed background layer image can depict an entirety of the background of the image as if the background was not occluded by any objects in the image. The completed layer images can depict an entirety of the at least one of the plurality of objects as if it was not occluded by the one or more other objects. Each of the completed layer images can include a red, green, blue (RGB) image.

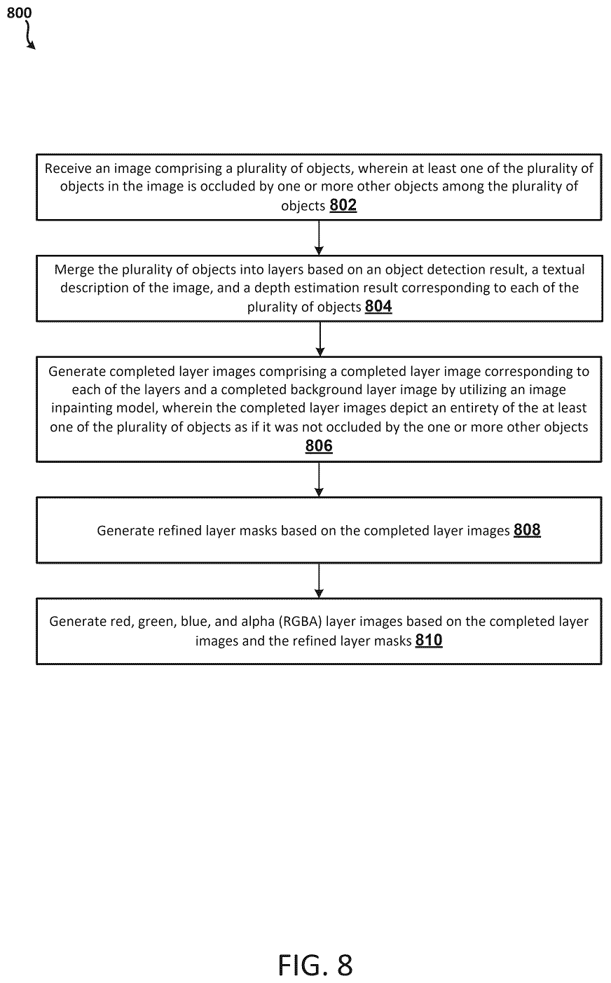

FIG. 8 shows an example process 800 for implementing automatic layer decomposition. Although depicted as a sequence of operations in FIG. 8, those of ordinary skill in the art will appreciate that various embodiments may add, remove, reorder, or modify the depicted operations.

At 802, an image (e.g., image 101, image 301, image 401) can be received. The image can include or depict a plurality of objects. The image may comprise, or depict, a plurality of objects. At least one of the plurality of objects in the image can be at least partially occluded by (e.g., blocked by) one or more other objects among the plurality of objects.

Object detection results can be generated. The object detection results can be generated based on detecting the plurality of objects in the image. The object detection results can include an object detection result corresponding to each of the plurality of objects. Textual descriptions of the image can be generated. The textual descriptions can include a textual description corresponding to each of the plurality of objects. The textual description of the image can be generated using a machine learning model, such as a multi-model large language model or a large vision-language model. Depth estimation results can be generated. The depth estimation results can be generated by predicting a depth map of the image. The depth estimation results can include a depth estimation result corresponding to each of the plurality of objects. At 804, the plurality of objects can be merged into layers. The plurality of objects can be merged into layers based on the object detection result, the textual description, and the depth estimation result corresponding to each of the plurality of objects.

At 806, completed layer images can be generated. The completed layer images can include a completed layer image corresponding to each of the layers and a completed background layer image. The completed layer images can be generated utilizing an image inpainting model. The completed layer images can depict an entirety of the at least one of the plurality of objects as if it was not occluded by the one or more other objects. Each of the completed layer images can include a red, green, blue (RGB) image.

At 808, refined layer masks can be generated. The refined layer masks can be generated based on the completed layer images. The refined layer masks can include a refined mask (e.g., an alpha mask, an alpha channel) for each of the completed layer images. At 810, red, green, blue, and alpha (RGBA) layer images can be generated. The RGBA layer images can be generated based on the completed layer images and the refined layer masks. Alpha generation models can be utilized to transform each of the completed layer images and the corresponding refined layer mask into a RGBA image.

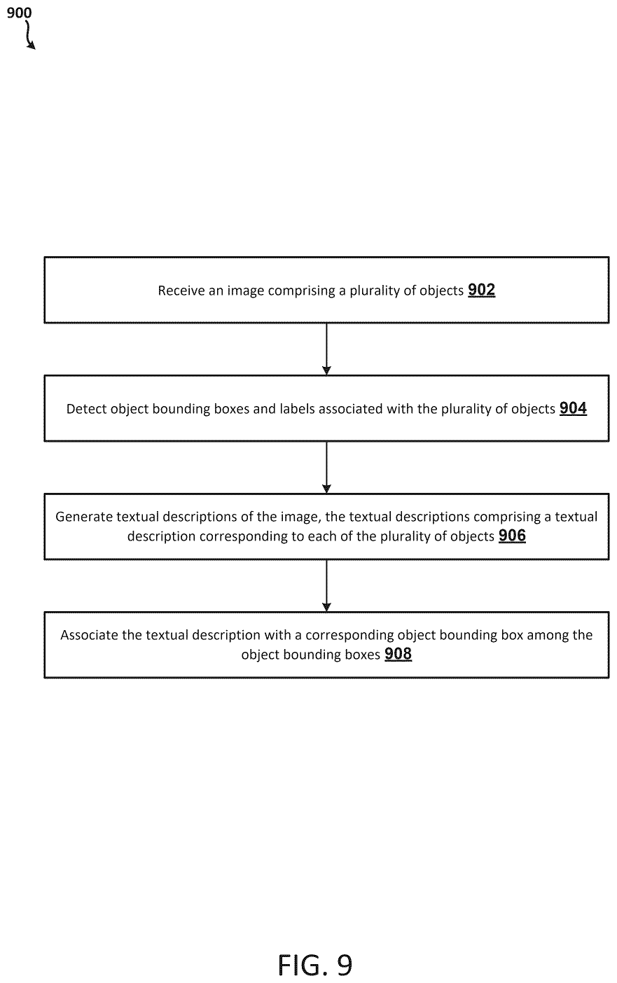

FIG. 9 shows an example process 900 for implementing automatic layer decomposition. Although depicted as a sequence of operations in FIG. 9, those of ordinary skill in the art will appreciate that various embodiments may add, remove, reorder, or modify the depicted operations.

At 902, an image (e.g., image 101, image 301, image 401) can be received. The image can include or depict a plurality of objects. The image may comprise, or depict, a plurality of objects. At 904, object detection results can be generated. The object detection results can be generated based on detecting the plurality of objects in the image. The object detection results can include an object detection result corresponding to each of the plurality of objects. Generating the object detection results based on detecting the plurality of objects in the image can include detecting object bounding boxes and labels associated with the plurality of objects.

At 906, textual descriptions of the image can be generated. The textual descriptions can include a textual description corresponding to each of the plurality of objects. The textual descriptions of the image can be generated using a machine learning model, such as a multi-model large language model or a large vision-language model. The image and a prompt can be input into the machine learning model. The prompt can instruct the machine learning model to generate a textual description corresponding to each of the plurality of objects in the image. The machine learning model can generate the textual descriptions of the image based on the image and the prompt.

At 908, the object detection result can be associated with (e.g., mapped to) the textual description corresponding to each of the plurality of objects. Associating the object detection result with the textual description corresponding to each of the plurality of objects can include associating the textual description with a corresponding object bounding box among the object bounding boxes. The object detection result can be associated with the textual description corresponding to each of the plurality of objects using a machine learning model, such as a large language model.

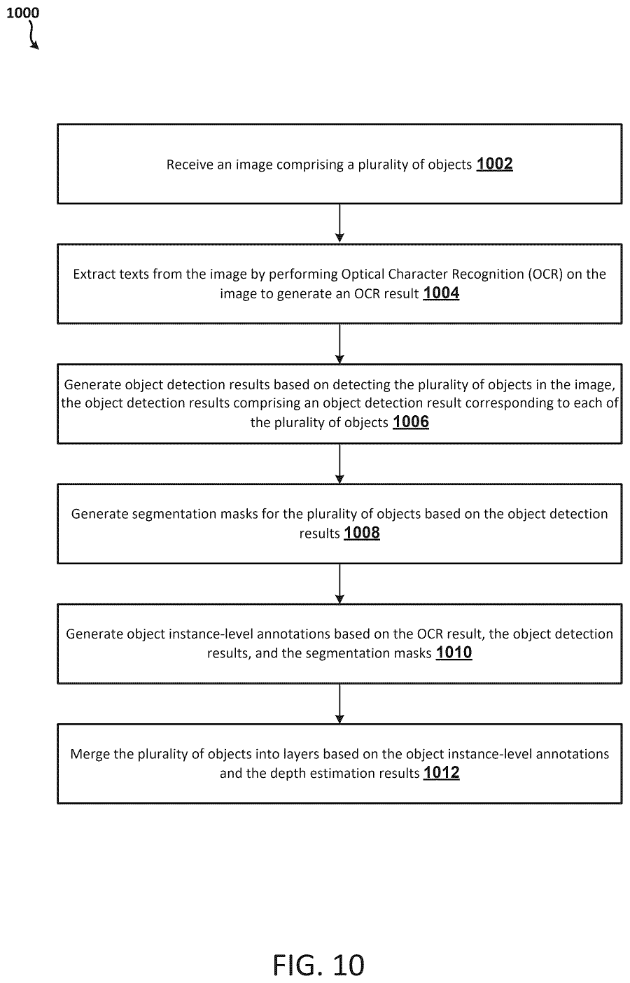

FIG. 10 shows an example process 1000 for implementing automatic layer decomposition. Although depicted as a sequence of operations in FIG. 10, those of ordinary skill in the art will appreciate that various embodiments may add, remove, reorder, or modify the depicted operations.

At 1002, an image (e.g., image 101, image 301, image 401) can be received. The image can include or depict a plurality of objects. The image may comprise, or depict, a plurality of objects. Optical Character Recognition (OCR) can be performed on the image. At 1004, texts can be extracted from the image by performing OCR on the image to generate an OCR result. At 1006, object detection results can be generated. The object detection results can be generated based on detecting the plurality of objects in the image. The object detection results can include an object detection result corresponding to each of the plurality of objects. Generating the object detection results based on detecting the plurality of objects in the image can include detecting object bounding boxes and labels associated with the plurality of objects.

At 1008, segmentation masks for the plurality of objects can be generated. The segmentation masks can be generated based on the object detection results. At 1010, object instance-level annotations can be generated. The object instance-level annotations can be generated based on the OCR result, the object detection results, and the segmentation masks. At 1012, the plurality of objects can be merged into layers. The plurality of objects can be merged into layers based on the object instance-level annotations and the depth estimation results.

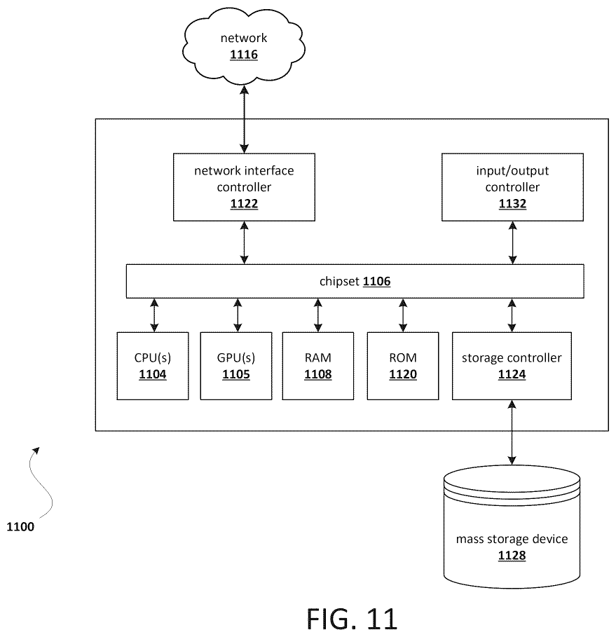

FIG. 11 illustrates a computing device that may be used in various aspects, such as the services, networks, modules, and/or devices depicted in any of FIGS. 1-3. With regard to FIGS. 1-3, any or all of the components may each be implemented by one or more instance of a computing device 1100 of FIG. 11. The computer architecture shown in FIG. 11 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1100 may include a baseboard, or “motherboard,” which is a printed circuit board to which a multitude of components or devices may be connected by way of a system bus or other electrical communication paths. One or more central processing units (CPUs) 1104 may operate in conjunction with a chipset 1106. The CPU(s) 1104 may be standard programmable processors that perform arithmetic and logical operations necessary for the operation of the computing device 1100.

The CPU(s) 1104 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1104 may be augmented with or replaced by other processing units, such as GPU(s) 1105. The GPU(s) 1105 may comprise processing units specialized for but not necessarily limited to highly parallel computations, such as graphics and other visualization-related processing.

A chipset 1106 may provide an interface between the CPU(s) 1104 and the remainder of the components and devices on the baseboard. The chipset 1106 may provide an interface to a random-access memory (RAM) 1108 used as the main memory in the computing device 1100. The chipset 1106 may further provide an interface to a computer-readable storage medium, such as a read-only memory (ROM) 1120 or non-volatile RAM (NVRAM) (not shown), for storing basic routines that may help to start up the computing device 1100 and to transfer information between the various components and devices. ROM 1120 or NVRAM may also store other software components necessary for the operation of the computing device 1100 in accordance with the aspects described herein.

The computing device 1100 may operate in a networked environment using logical connections to remote computing nodes and computer systems through local area network (LAN). The chipset 1106 may include functionality for providing network connectivity through a network interface controller (NIC) 1122, such as a gigabit Ethernet adapter. A NIC 1122 may be capable of connecting the computing device 1100 to other computing nodes over a network 1116. It should be appreciated that multiple NICs 1122 may be present in the computing device 1100, connecting the computing device to other types of networks and remote computer systems.

The computing device 1100 may be connected to a mass storage device 1128 that provides non-volatile storage for the computer. The mass storage device 1128 may store system programs, application programs, other program modules, and data, which have been described in greater detail herein. The mass storage device 1128 may be connected to the computing device 1100 through a storage controller 1124 connected to the chipset 1106. The mass storage device 1128 may consist of one or more physical storage units. The mass storage device 1128 may comprise a management component. A storage controller 1124 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1100 may store data on the mass storage device 1128 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1128 is characterized as primary or secondary storage and the like.

For example, the computing device 1100 may store information to the mass storage device 1128 by issuing instructions through a storage controller 1124 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1100 may further read information from the mass storage device 1128 by detecting the physical states or characteristics of one or more particular locations within the physical storage units.

In addition to the mass storage device 1128 described above, the computing device 1100 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1100.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1128 depicted in FIG. 11, may store an operating system utilized to control the operation of the computing device 1100. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1128 may store other system or application programs and data utilized by the computing device 1100.

The mass storage device 1128 or other computer-readable storage media may also be encoded with computer-executable instructions, which, when loaded into the computing device 1100, transforms the computing device from a general-purpose computing system into a special-purpose computer capable of implementing the aspects described herein. These computer-executable instructions transform the computing device 1100 by specifying how the CPU(s) 1104 transition between states, as described above. The computing device 1100 may have access to computer-readable storage media storing computer-executable instructions, which, when executed by the computing device 1100, may perform the methods described herein.

A computing device, such as the computing device 1100 depicted in FIG. 11, may also include an input/output controller 1132 for receiving and processing input from a number of input devices, such as a keyboard, a mouse, a touchpad, a touch screen, an electronic stylus, or other type of input device. Similarly, an input/output controller 1132 may provide output to a display, such as a computer monitor, a flat-panel display, a digital projector, a printer, a plotter, or other type of output device. It will be appreciated that the computing device 1100 may not include all of the components shown in FIG. 11, may include other components that are not explicitly shown in FIG. 11, or may utilize an architecture completely different than that shown in FIG. 11.

As described herein, a computing device may be a physical computing device, such as the computing device 1100 of FIG. 11. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed IS:

1. A method of implementing automatic layer decomposition, comprising:
receiving an image comprising a plurality of objects;
generating object detection results based on detecting the plurality of objects in the image, the object detection results comprising an object detection result corresponding to each of the plurality of objects;
generating textual descriptions of the image, the textual descriptions comprising a textual description corresponding to each of the plurality of objects;
associating the object detection result with the textual description corresponding to each of the plurality of objects;
generating depth estimation results by predicting a depth map of the image, the depth estimation results comprising a depth estimation result corresponding to each of the plurality of objects; and
merging the plurality of objects into layers based on the object detection result, the textual description, and the depth estimation result corresponding to each of the plurality of objects.

2. The method of claim 1, wherein at least one of the plurality of objects in the image is occluded by one or more other objects among the plurality of objects, and wherein the method further comprises:
generating occlusion relation graphs associated with the image; and
sorting the plurality of objects based on the depth estimation results and the occlusion relation graphs in a foreground-to-background order.

3. The method of claim 2, further comprising:
generating inpainting masks corresponding to the layers; and
generating completed layer images comprising a completed layer image corresponding to each of the layers and a completed background layer image by utilizing an image inpainting model, wherein the completed layer images depict an entirety of the at least one of the plurality of objects as if it was not occluded by the one or more other objects.

4. The method of claim 3, further comprising:
generating refined layer masks based on the completed layer images; and
generating red, green, blue, and alpha (RGBA) layer images based on the completed layer images and the refined layer masks.

5. The method of claim 1, wherein the generating object detection results based on detecting the plurality of objects in the image comprises:
detecting object bounding boxes and labels associated with the plurality of objects.

6. The method of claim 5, wherein the associating the object detection result with the textual description corresponding to each of the plurality of objects comprises:
associating the textual description with a corresponding object bounding box among the object bounding boxes.

7. The method of claim 1, further comprising:
extracting texts from the image by performing Optical Character Recognition (OCR) on the image to generate an OCR result;
generating segmentation masks for the plurality of objects based on the object detection results; and
generating object instance-level annotations based on the OCR result, the object detection results, and the segmentation masks.

8. The method of claim 7, wherein the merging the plurality of objects into layers comprises:
merging the plurality of objects into the layers based on the object instance-level annotations and the depth estimation results.

9. A system of implementing automatic layer decomposition, comprising:
at least one processor; and
at least one memory communicatively coupled to the at least one processor and comprising computer-readable instructions that upon execution by the at least one processor cause the at least one processor to perform operations comprising:
receiving an image comprising a plurality of objects;
generating object detection results based on detecting the plurality of objects in the image, the object detection results comprising an object detection result corresponding to each of the plurality of objects;
generating textual descriptions of the image, the textual descriptions comprising a textual description corresponding to each of the plurality of objects;
associating the object detection result with the textual description corresponding to each of the plurality of objects;
generating depth estimation results by predicting a depth map of the image, the depth estimation results comprising a depth estimation result corresponding to each of the plurality of objects; and
merging the plurality of objects into layers based on the object detection result, the textual description, and the depth estimation result corresponding to each of the plurality of objects.

10. The system of claim 9, wherein at least one of the plurality of objects in the image is occluded by one or more other objects among the plurality of objects, and wherein the method further comprises:
generating occlusion relation graphs associated with the image; and
sorting the plurality of objects based on the depth estimation results and the occlusion relation graphs in a foreground-to-background order.

11. The system of claim 10, the operations further comprising:
generating inpainting masks corresponding to the layers; and
generating completed layer images comprising a completed layer image corresponding to each of the layers and a completed background layer image by utilizing an image inpainting model, wherein the completed layer images depict an entirety of the at least one of the plurality of objects as if it was not occluded by the one or more other objects.

12. The system of claim 11, the operations further comprising:
generating refined layer masks based on the completed layer images; and
generating red, green, blue, and alpha (RGBA) layer images based on the completed layer images and the refined layer masks.

13. The system of claim 9, wherein the generating object detection results based on detecting the plurality of objects in the image comprises:
detecting object bounding boxes and labels associated with the plurality of objects.

14. The system of claim 13, wherein the associating the object detection result with the textual description corresponding to each of the plurality of objects comprises:
associating the textual description with a corresponding object bounding box among the object bounding boxes.

15. The system of claim 9, the operations further comprising:
extracting texts from the image by performing Optical Character Recognition (OCR) on the image to generate an OCR result;
generating segmentation masks for the plurality of objects based on the object detection results; and
generating object instance-level annotations based on the OCR result, the object detection results, and the segmentation masks.

16. A non-transitory computer-readable storage medium, storing computer-readable instructions that upon execution by a processor cause the processor to implement operations comprising:
receiving an image comprising a plurality of objects;
generating object detection results based on detecting the plurality of objects in the image, the object detection results comprising an object detection result corresponding to each of the plurality of objects;
generating textual descriptions of the image, the textual descriptions comprising a textual description corresponding to each of the plurality of objects;
associating the object detection result with the textual description corresponding to each of the plurality of objects;
generating depth estimation results by predicting a depth map of the image, the depth estimation results comprising a depth estimation result corresponding to each of the plurality of objects; and
merging the plurality of objects into layers based on the object detection result, the textual description, and the depth estimation result corresponding to each of the plurality of objects.

17. The non-transitory computer-readable storage medium of claim 16, wherein at least one of the plurality of objects in the image is occluded by one or more other objects among the plurality of objects, and wherein the method further comprises:
generating occlusion relation graphs associated with the image; and
sorting the plurality of objects based on the depth estimation results and the occlusion relation graphs in a foreground-to-background order.

18. The non-transitory computer-readable storage medium of claim 17, the operations further comprising:
generating inpainting masks corresponding to the layers; and
generating completed layer images comprising a completed layer image corresponding to each of the layers and a completed background layer image by utilizing an image inpainting model, wherein the completed layer images depict an entirety of the at least one of the plurality of objects as if it was not occluded by the one or more other objects;
generating refined layer masks based on the completed layer images; and
generating red, green, blue, and alpha (RGBA) layer images based on the completed layer images and the refined layer masks.

19. The non-transitory computer-readable storage medium of claim 16, wherein the generating object detection results based on detecting the plurality of objects in the image comprises:
detecting object bounding boxes and labels associated with the plurality of objects, and
wherein the associating the object detection result with the textual description corresponding to each of the plurality of objects comprises:
associating the textual description with a corresponding object bounding box among the object bounding boxes.

20. The non-transitory computer-readable storage medium of claim 16, the operations further comprising:
extracting texts from the image by performing Optical Character Recognition (OCR) on the image to generate an OCR result;
generating segmentation masks for the plurality of objects based on the object detection results; and
generating object instance-level annotations based on the OCR result, the object detection results, and the segmentation masks.
